(19) United States
(12) Patent Application Publication
(10) Pub. No.: US 2005/0120833 A1
(43) Pub. Date: Jun. 9, 2005

(54) Ratchet wrench having device for indication of wrench size and turning orientation

(76) Inventor: Chih-Min Chang, Chang Hua Hsien (TW)

Correspondence Address: BACON & THOMAS, PLLC, 625 SLATERS LANE, FOURTH FLOOR, ALEXANDRIA, VA, 22314, US

(21) Appl. No.: 10/726,600

(22) Filed: Dec. 4, 2003

(51) Int. Cl. B25B 13/46

(52) U.S. Cl. 81/60

(57) ABSTRACT

A ratchet wrench has a wrench body having a hole at an end thereof and a chamber communicated with the hole. A ratchet wheel has an annular teeth portion at an outer surface thereof. The ratchet wheel is rotatably mounted in the hole of the wrench body. A pawl for meshing the teeth portion of the ratchet wheel and a spring having an end stopped at the pawl are mounted in the chamber of the wrench body. A ring member is mounted in the hole of the wrench body and has a predetermined color that is different from a color of the wrench body and visible from outside of the ratchet wrench for indicating the turning orientation of loosing and/or tightening.

### BACKGROUND OF THE INVENTION

1. Field of the Invention

The present invention relates generally to a hand tool, and more particularly to a ratchet wrench, which the size of the wrench and the turning orientation are easy to identify.

2. Description of the Related Art

A conventional ratchet wrench has a color of silver and is labeled with wrench size thereon. The ratchet wrench has a handle. A ratchet wheel and a pawl are mounted at an end of the handle. The pawl restricts the ratchet wheel for only rotation along one orientation. If a bolt or a nut needs to be loosed, the ratchet wheel is engaged with the bolt (or nut) and exerts the handle for rotation counterclockwise. Under such condition, the handle can be turned reversibly and leave the bolt keeping still, such that the wrench can turn the bolt loose repeatedly. If the ratchet wrench is engaged with the bolt via the other side thereof, the ratchet wrench can turn a bolt or a nut tight repeatedly.

The conventional ratchet wrench lacks of any sign indicating which orientation is to tight and which orientation is to loose. User needs try and error every time when turning a nut or a bolt. Sometime user may hit the target for the first time, but sometime needs two times of try. The problem of confusing with the turning orientations of the conventional ratchet wrench is occurred both on old hands and new hands.

The ratchet wrenches have metric system and British system in the present market. If the user has both metric wrenches and British wrenches and put them in the same place, he/she might confuse which one is metric wrench and which one is British wrench when the sizes of the wrenches are close. User has to read the sign on the wrench to identify the exact size thereof and that makes user inconvenient.

### SUMMARY OF THE INVENTION

The primary objective of the present invention is to provide a ratchet wrench, which is easy to be identified which one is metric wrench and which one is British wrench.

The secondary objective of the present invention is to provide a ratchet wrench, which is easy to be identified which orientation is to loose a bolt/nut and which orientation is to tight a bolt/nut.

According to the objectives of the present invention, a ratchet wrench comprises a wrench body having a hole at an end thereof and a chamber communicated with the hole. A ratchet wheel has an annular teeth portion at an outer surface thereof. The ratchet wheel is rotatably mounted in the hole of the wrench body. A pawl for meshing the teeth portion of the ratchet wheel and a spring having an end stopped at the pawl are mounted in the chamber of the wrench body. A ring member is mounted in the hole of the wrench body and has a predetermined color that is different from a color of the wrench body and visible from outside of the ratchet wrench for indicating the turning orientation of loosing and/or tightening.

Preferably, an identification layer having a color different from the wrench body is disposed on a ring member instead of the above-mentioned colored ring member.

Preferably, the ring member is integrally formed at an end of the ratchet wheel.

### BRIEF DESCRIPTION OF THE DRAWINGS

FIG. 1 is an exploded view of a first preferred embodiment of the present invention;

FIG. 2 is a perspective view of the first preferred embodiment of the present invention;

FIG. 3 is a sectional view along line 3-3 of FIG. 1;

FIG. 4 is a sectional view of the ring member of the first preferred embodiment of the present invention;

FIG. 5 is a sectional view of a second preferred embodiment of the present invention;

FIG. 6 is a sectional view of the ring member of the second preferred embodiment of the present invention, and

FIG. 7 is a sectional view of the ring member of a third preferred embodiment of the present invention.

### DETAILED DESCRIPTION OF THE INVENTION

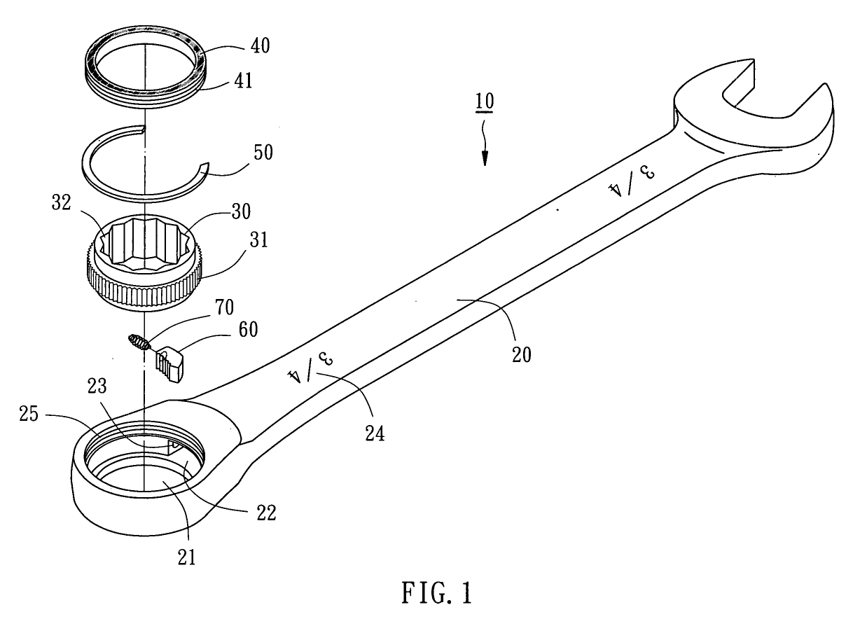

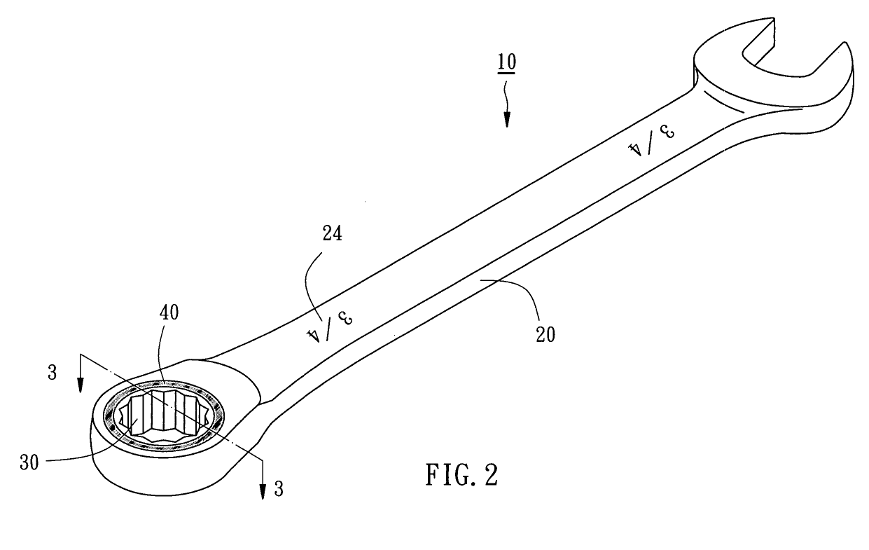

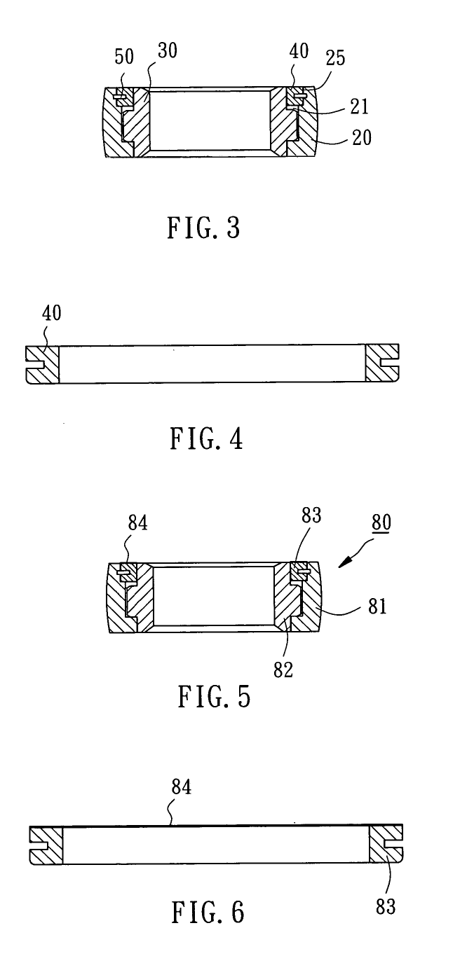

As shown in FIG. 1 and FIG. 2, a ratchet wrench 10 of the first preferred embodiment of the present invention comprises elements as follows.

An elongated wrench body 20 has a hole 21 at an end thereof, a chamber 22 communicated with the hole 21, a recess 23 on a sidewall of the chamber 22 and an annular slot 25 on a sidewall of the hole 21. The wrench body 20 is provided with a sign 24 indicating the size of the wrench.

A ratchet wheel 30 is mounted in the hole 21 of the wrench body 20 for free rotation. The ratchet wheel 30 has a teeth portion 31 on an outer surface thereof and a polygonal hole 32 at a center thereof.

A ring member 40 has a color different from the color of the wrench body 20. The ring member 40 has an annular slot 41 at middle of an outer surface thereof. The ring member 40 is mounted in the holes 21 of the wrench body 20 between the ratchet wheel 30 and the sidewall of the hole 21. A C-ring 50 is received in both of the annular slots 25 and 41 of the wrench body 20 and the ring member 40 to restrain the ratchet wheel 30 in the hole 21 but still leaves the ratchet wheel 30 for free rotation.

A pawl 60 is received in the chamber 22 of the wrench body 20 for meshing the teeth portion 31 of the ratchet wheel 30.

A spring 70 has a portion thereof received in the recess 23 and has a distal end thereof against the pawl 60 to provide the pawl 60 a spring force.

The ratchet wrench 10 of the present invention provides the ring member 40 having the color different from the color of the wrench body 20. It makes the user easy to identify which one is the metric wrench and which one is the British wrench. For example, we provide the metric wrenches having blue ring member and the British wrenches having red ring member, such that user can identify these wrenches simply by viewing the color of the ring member 40 thereon.

The ring member 40 has an additional indication of turning orientation. For example, if a user wants to loose the bolt, the ratchet wrench 10 of the present invention is fitted to the bolt with the colored ring member 40 facing outward which is visible for the user. On the other hand, if a user wants to tight the bolt, the ratchet wrench 10 is fitted to the bolt with the colored ring member 40 facing inward which is invisible for the user. So that the user is easy to identify the turning orientation of the ratchet wrench 10 of the present invention via the ring member 40.

The C-ring 50 is hidden in the annular slots 25 and 41 of the wrench body 20 and the ring member 40. It is invisible from outside so that the C-ring 50 will not affect the indication of the ring member 40.

FIG. 5 shows a ratchet wrench 80 of the second preferred embodiment of the present invention, which is similar to the first preferred embodiment, having a wrench body 81, a ratchet wheel 82 and a ring member 83. The ring member 83 is coated with an identification layer 84 as shown in FIG. 6. The identification layer 84 has a predetermined color and is made by printing, plating, painting or the other similar ways. The color of the identification layer 84 is different from the color of the wrench body 81 to serve the functions as described above.

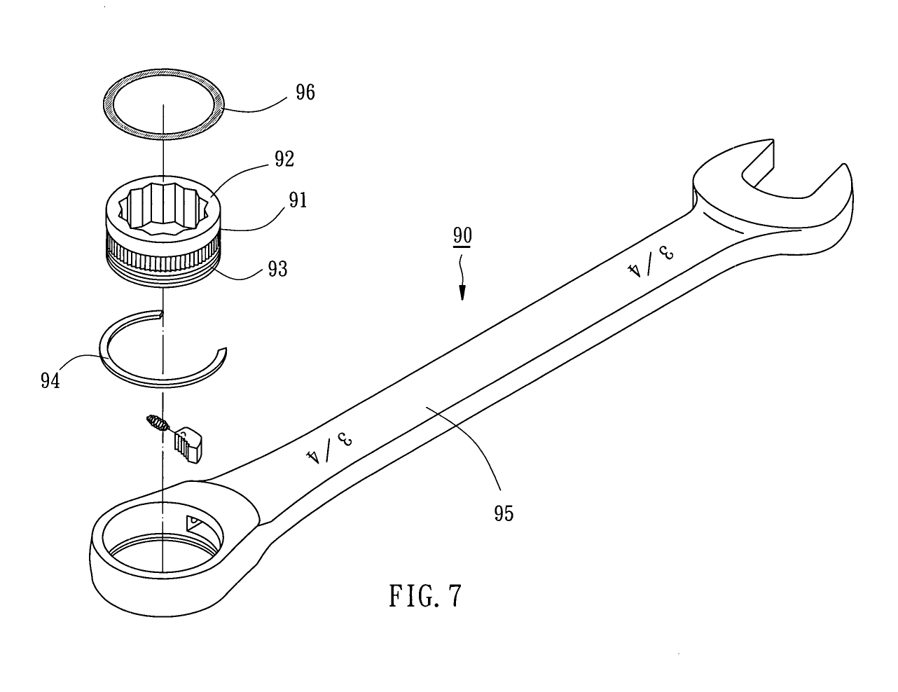

FIG. 7 shows a ratchet wrench 90 of the third preferred embodiment of the present invention. A ring member 93 is integrally formed at an end of a ratchet wheel 91. The ratchet wheel 91 has an annular slot 93 at an outer surface of the other end. A C-ring 94 is mounted in the annular slot 93 to restrain the ratchet wheel 91 in a wrench body 95. The feature of the third preferred embodiment is characterized in that the ratchet wheel 91 and the ring member 93 are molded in a single element. An identification layer 96, which is an annular film, is attached on the ring member 93. The identification layer 96 has a color different from the color of the wrench body 95 to serve the functions as described above.

The main scope of the present invention is to provide a ring member having a color different from the color of the wrench body for indication of the wrench's size and the turning orientation.

1. (Canceled)

2. (Canceled)

3. (Canceled)

4. A ratchet wrench, comprising;
a wrench body having a hole and a chamber in communication with said hole;
a ratchet wheel rotatably mounted in the hole of the wrench body and having an annular teeth portion at an outer surface thereof and a polygonal hole at a center thereof;
a ring member mounted in the hole of the wrench body to restrain the ratchet wheel;
an identification layer disposed on the ring member and having a predetermined color that is different from a color of the wrench body and visible from outside of the ratchet wrench;
a pawl received in the chamber of the wrench body for meshing with the teeth portion of the ratchet wheel, and
a spring having two ends respectively stopped at the wrench body and the pawl.

5. The ratchet wrench as defined in claim 4, wherein the identification layer is a coating layer coated on the ring member by printing, painting or plating.

6. The ratchet wrench as defined in claim 4, wherein the identification layer is a film attached on the ring member.

7. A ratchet wrench comprising:
a wrench body having a hole and a chamber in communication with said hole;
a ratchet wheel rotatable mounted in the hole of the wrench body and having an annular teeth portion at an outer surface thereof and a polygonal hole at a center thereof;
a ring member mounted in the hole of the wrench body;
an identification layer disposed on the ring member and having a predetermined color that is different from a color of the wrench body and visible from outside of the ratchet wrench;
a pawl received in the chamber of the wrench body for meshing with the teeth portion of the ratchet wheel, and
a spring having two ends respectively stopped at the wrench body and the pawl,
wherein the ring member is integrally formed at an end of the rachet wheel; and the ratchet wheel has an annular slot at an outer surface thereof in which a C-ring is mounted; said C-ring being stopped at a wall of the hole of the wrench body.
